(19) United States
(12) Patent Application Publication
(10) Pub. No.: US 2026/0193498 A1
(43) Pub. Date: Jul. 9, 2026

(54) METHOD OF UNDERWATER BONDING

(71) Applicant: Henkel AG & Co. KGaA, Duesseldorf (DE)

(72) Inventors: Emer Ward, Dublin (IE); Susan Reilly, Clane (IE); Frances Murphy, Ratoath (IE); Patricia Hedderman, Dublin (IE); Michael Jordan, Dublin (IE)

(21) Appl. No.: 19/553,915

(22) Filed: Mar. 2, 2026

Related U.S. Application Data
(63) Continuation of application No. PCT/EP2024/072602, filed on Aug. 9, 2024.

(30) Foreign Application Priority Data
Sep. 4, 2023 (GB) 2313468.7

(51) Int. Cl. C09J 135/04; B32B 7/12; B32B 15/01; B32B 27/08; B32B 37/12; C09J 5/00; C09J 11/08

(52) U.S. Cl. CPC C09J 135/04; B32B 7/12; B32B 37/1284; C09J 5/00; C09J 11/08; B32B 15/01; B32B 27/08; B32B 2250/02; C09J 2400/166; C09J 2400/228

(57) ABSTRACT

A method of bonding substrates that are underwater comprising applying, underwater, a cyanoacrylate composition to at least one substrate and allowing the composition to cure underwater.

### FIELD

The present invention provides a method of underwater bonding by curable cyanoacrylate compositions.

### BRIEF DESCRIPTION OF RELATED TECHNOLOGY

Curable compositions such as cyanoacrylate adhesives are well recognized for their excellent ability to rapidly bond a wide range of substrates, generally in a number of minutes and depending on the particular substrate, often in a number of seconds.

Cyanoacrylate adhesive compositions are well known, and widely used as quick setting, instant adhesives with a wide variety of uses. See H. V. Coover, D. W. Dreifus and J. T. O'Connor, “Cyanoacrylate Adhesives” in Handbook of Adhesives, 27, 463-77, I. Skeist, ed., Van Nostrand Reinhold, New York, 3rd ed. (1990). See also G. H. Millet, “Cyanoacrylate Adhesives” in Structural Adhesives: Chemistry and Technology, S. R. Hartshorn, ed., Plenum Press, New York, p. 249-307 (1986).

Cyanoacrylates adhesive compositions are well suited to curing in air. Beneficially these compositions achieve handling strength in seconds when cured in air and >60% strength within 1 minute when cured in air.

Polymerization of cyanoacrylates is initiated by nucleophiles found under normal atmospheric conditions on most surfaces. The initiation by surface chemistry means that sufficient initiating species are available when two surfaces are in close contact with a small layer of cyanoacrylate between the two surfaces. Under these conditions a strong bond is obtained in a short period of time. Thus, in essence the cyanoacrylate often functions as an instant adhesive.

Cyanoacrylate adhesive compositions are not traditionally used for underwater applications because cyanoacrylate adhesive compositions are difficult to dispense underwater. It will be appreciated that underwater means that the substrates to be bonded are completely submerged in water. The water is in contact with the substrates. Underwater as used herein does not refer to a situation where the substrates are underwater but not in contact with the water, for example underwater does not refer to substrates which are placed in a waterproof container and this container is in contact with water while the substrate are not in contact with water as the waterproof container keeps them dry. In particular the present invention is concerned with methods employing cyanoacrylate adhesive which is dispensed from a container while underwater. In such cases the cyanoacrylate adhesive is dispensed through the water onto a substrate surface and that substrate surface is also in contact with water.

Dispensing cyanoacrylate adhesive compositions underwater causes the composition to react with the water and the compositions may prematurely cure prior to being applied to the substrates it is intended to bond. Indeed cyanoacrylate compositions are well known to be sensitive to water and in some cases even trace amounts of water can cause premature cure for example during storage for later use.

Cyanoacrylate adhesive performance, particularly durability, oftentimes becomes suspect when exposed to water. A bond formed using cured cyanoacrylate compositions can be susceptible to water. For example the bond formed may ultimately fail due to degradation of the cured cyanoacrylate composition over time when exposed to water. In general exposure to water causes loss of bond strength over time.

Cyanoacrylate adhesive compositions when dispensed underwater may also partially cure when it is applied to a first substrate but prior to joining to a second substrate. While it may be possible in this case to form a bond between the substrates the bond will be weak as the composition has partially part cured before the substrates are jointed.

To overcome these issues typically cyanoacrylate adhesive compositions may be applied to substrates in air and then the bonded substrates are placed underwater.

Underwater bonding using cyanoacrylate adhesive compositions would be advantageous for applications where the properties of cyanoacrylate adhesive compositions would be beneficial. In situations where it is difficult to remove the substrates from water it would be beneficial to both dispense and to cure a cyanoacrylate adhesive composition underwater. For example when performing boat repairs it would be beneficial to use a cyanoacrylate adhesive composition for bonding parts of the boat which are underwater.

It would be beneficial to provide alternative adhesives which can: (1) be dispensed while submerged, (2) remain uncured for sufficient time to allow application to a substrate to be bonded; (3) subsequently cure, desirably with a short open time (4) develop high strength bonds, and (5) retain bond strength. All of the foregoing need to be achieved underwater.

### SUMMARY

In one aspect, the present invention provides a method of bonding substrates that are underwater comprising:
(a) applying, underwater, a cyanoacrylate composition to at least one substrate, wherein the cyanoacrylate composition comprises:
i. a first part comprising a cyanoacrylate component and a peroxide catalyst; and
ii. a second part comprising a free radical curable component and a transition metal,
wherein when mixed together the peroxide catalyst initiates cure of the free radical curable component and the transition metal initiates cure of the cyanoacrylate component, and
(b) allowing the composition to cure underwater.

Underwater means that the substrates are submerged in water so that the water is in contact with the substrates at the same time as the composition is applied. The substrates are not, for example, in a waterproof container so that they are not directly exposed to the water. Beneficially the method allows bonding underwater in applications traditionally excluded due to an inability to remove and dry the assembly before bonding.

Beneficially the composition applied in the method can be dispensed while submerged, remains uncured for sufficient time to allow application to a substrate to be bonded; and subsequently cures with a short cure time. Beneficially the cured composition which was allowed to cure underwater develops high strength bonds, and retains that bond strength over time. Desirably the composition has a sufficiently long open time so that it can be dispensed, applied, and the substrate(s) bonded before the composition cures, but a faster cure time than compositions used in previous methods in order to minimise the time that the user must spend underwater.

The perceived shortcomings of cyanoacrylate compositions for bonding substrates that are underwater may be overcome with the cyanoacrylate hybrid composition disclosed herein. The cyanoacrylate compositions used in the method of the invention are curable. All of the desirable properties of the present invention refer to those properties of the composition in an underwater environment. Compositions of the invention remain in place when dispensed. Compositions of the method can be dispensed underwater, for example there is no premature cure upon first contact with water which would prevent dispensing of the composition onto a substrate. It is possible a skin may form where there is initial contact with water but there is no cure through the volume of the composition that would prevent dispensing. Compositions of the method may have a suitable viscosity to allow them to be dispensed. The compositions may have a suitable buoyancy. For example it is appropriate that a composition of the method is not moved out of position by the forces caused by normal water currents.

The composition may be dispensed underwater and used in a method of bonding substrates that are underwater. While not wishing to be bound by a theory it is thought that, a combination of cure speed modulation due to the acrylate portion of the hybrid and the material's inherent high viscosity, may impart this unexpected open time in an aqueous environment. The first part of the composition may have a cone and plate viscosity of from 4000 to 11000 mPa·s. The second part may have a cone and plate viscosity of from 45000 to 75000 mPa·s.

The cyanoacrylate composition may be applied in a ratio of the first part to second part of about a 1:1 ratio by volume.

The method of bonding substrates that are underwater may comprise exposing the composition to water for up to 45 seconds prior to joining the surface of the second substrate with the coated surface of the first substrate. This may be referred to as the open time of the composition. The composition may have a good open time of up to 90 seconds, for example up to 60 seconds, for example up to 45 seconds. Beneficially a good open time allows time for the substrates to be correctly mated prior to the composition curing. The substrates can be assembled into an assembly in the correct configuration as the good open time allows time for assembly. The composition has a good open time and allows for nozzles (through which the composition is dispensed to be applied) to be changed underwater without the composition curing. The composition may form a film in the topmost layer of the film but does not cure in the bulk and has good open time.

In the method of bonding substrates that are underwater the composition does not mix with the water, for example in a water column, or otherwise disperse in water. The physical properties of the composition, for example its viscosity, are such that it does not mix with the water and stays where it is applied. The outermost layer of the composition may cure to form a film which prevents the bulk of the composition from coming into contact with the water. In this respect, cure through volume of the composition can occur later after two substrates are brought together.

In the method of bonding substrates that are underwater one or both substrates may be a metal, for example wherein one or both substrates may be steel.

In the method of bonding substrates that are underwater at least one substrate may comprise a material selected from the group comprising: steel, aluminium, wood, plastics, fibreglass, a building material including aggregates, sand, concrete/cement materials including ferrocements, fibre-reinforced plastic.

Suitably, both substrates may independently comprise a material selected from the group comprising: steel, aluminium, wood, plastics, fibreglass, a building material including aggregates, sand, concrete/cement materials including ferrocements, fibre-reinforced plastic.

In the method of bonding substrates that are underwater at least one substrate may be a watercraft, such as a boat or a ship, or a part thereof. The method may be used for affixing items to boats or ships, for example fitting sensors or attaching replacement parts, or for performing repairs on boats or ships. With the method of the invention this can be carried out without needing to return to land to remove the boat or ship from the water.

In the method of bonding substrates that are underwater at least one substrate may be a structure which is located underwater or a part of a structure which extends underwater, such as a bridge, oil or gas rig apparatus, pipeline, dam, wind turbine or similar. Such structures cannot be removed from the water so it is beneficial to be able to affix items, for example accessories, sensors or replacement parts, or to perform repairs while underwater.

In the method of bonding substrates that are underwater one or both substrates may be a metal. In the method of bonding substrates that are underwater one or both substrates may be a plastics material.

In the method of bonding substrates that are underwater the nozzle life may be at least 4 minutes, for example at least 5 minutes. The dispense nozzles have good nozzle life because the composition does not prematurely cure and block the nozzle. This is surprising as compositions comprising cyanoacrylate typically experience fast cure when exposed to moisture, for example when they are underwater. Beneficially the nozzle life is increased and thus allows more of the composition to be applied before the nozzle has to be changed.

The method of bonding substrates that are underwater may be carried out in water containing varying amounts of salts and/or minerals. For example, the method may be carried out in distilled water, or treated water such as in a public/mains water supply. The method may be carried out in freshwater such as in wells, rivers or lakes. The method may be carried out in saltwater, for example in seawater, for example in water having a salinity of from about 30 g/L to about 50 g/L.

The method of bonding substrates that are underwater may be carried out in water having a pH in the range of from about 6 to about 9, for example from about 6.5 to about 8 or from about 7.5 to about 8.5.

In the method of bonding substrates that are underwater the peroxide catalyst may comprise perbenzoates.

The invention further provides the use of a cyanoacrylate composition for underwater bonding of substrates wherein the composition comprises:
a first part comprising a cyanoacrylate component and t-butyl perbenzoate as a peroxide catalyst present in an amount from about 0.01% to about 10%, by weight of the cyanoacrylate component; and
a second part comprising a free radical curable component and a transition metal,
   wherein the cyanoacrylate component comprises H₂C═C(CN)—COOR, wherein R is selected from alkyl, alkoxyalkyl, cycloalkyl, alkenyl, aralkyl, aryl, allyl and haloalkyl groups, and wherein when mixed together the peroxide catalyst initiates cure of the free radical curable component and the transition metal initiates cure of the cyanoacrylate component.

The invention also provides an assembly comprising two underwater substrates that are bonded together by a cyanoacrylate composition comprising:
a first part comprising a cyanoacrylate component and t-butyl perbenzoate as a peroxide catalyst present in an amount from about 0.01% to about 10%, by weight of the cyanoacrylate component; and
a second part comprising a free radical curable component and a transition metal,
   wherein the cyanoacrylate component comprises H₂C═C(CN)—COOR, wherein R is selected from alkyl, alkoxyalkyl, cycloalkyl, alkenyl, aralkyl, aryl, allyl and haloalkyl groups, and wherein when mixed together the peroxide catalyst initiates cure of the free radical curable component and the transition metal initiates cure of the cyanoacrylate component. It will be appreciated that the assembly comprises two substrates bonded together by curing the cyanoacrylate composition.

In the assembly of the invention one or both substrates may be a metal. One or both substrates may be steel.

In the assembly of the invention one or both substrates may be a plastics material.

### DETAILED DESCRIPTION

The method of bonding substrates that are underwater comprises applying, underwater a composition as disclosed herein to at least one substrate and allowing the composition to cure.

The nozzle life may be at least 4 minutes, for example at least 5 minutes. This means that the composition will not cure in this time in a nozzle which is used to dispense while the composition is being applied. It is possible that a thin layer of the composition may cure at a nozzle tip where the composition is in contact with the water. The bulk of the composition in a nozzle body which is not in contact with water will remain uncured. It will still be possible to dispense the composition from the nozzle as the composition has a good nozzle life underwater.

Beneficially the composition may be exposed to water (for example immersed in water) for up to 45 seconds prior to joining the surface of the second substrate with the coated surface of the first substrate and the composition will remain uncured so that is possible to form a bond between the substrates.

The method comprises curing the composition underwater. The composition is not removed from water to cure. When cured the bond formed is strong. When cured the bond formed retains its strength over time making the method of the invention suitable for bonding substrates for long periods of time.

### Part A of the Composition

The cyanoacrylate component comprises cyanoacrylate monomers. The cyanoacrylate component may comprise H₂C═C(CN)—COOR, wherein R is selected from alkyl, alkoxyalkyl, cycloalkyl, alkenyl, aralkyl, aryl, allyl and haloalkyl groups, for example, wherein R is selected from C₁₋₁₅ alkyl, C₂₋₁₅ alkoxyalkyl, C₃₋₁₅ cycloalkyl, C₂₋₁₅ alkenyl, C₇₋₁₅ aralkyl, C₆₋₁₅ aryl, C₃₋₁₅ allyl and C₁₋₁₅ haloalkyl groups. Desirably, the cyanoacrylate monomer is selected from methyl cyanoacrylate, ethyl-2-cyanoacrylate (“ECA”), propyl cyanoacrylates, butyl cyanoacrylates (such as n-butyl-2-cyanoacrylate), octyl cyanoacrylates, allyl cyanoacrylate, ß-methoxyethyl cyanoacrylate and combinations thereof. A particularly desirable one is ethyl-2-cyanoacrylate.

The cyanoacrylate component may be included in the Part A composition in an amount within the range of from about 50 weight percent to about 99.98 weight percent, such as about 90 weight percent to about 99 weight percent being desirable, and about 92 weight percent to about 97 weight percent of the Part A composition being particularly desirable.

As the peroxide catalyst to be included in the Part A composition of the two part adhesive system, t-butyl perbenzoate may be used.

Typically, the amount of peroxide catalyst should fall in the range of about 0.001 weight percent up to about 10.00 weight percent of the composition, desirably about 0.01 weight percent up to about 5.00 weight percent of the composition, such as about 0.50 to 2.50 weight percent of the composition.

Additives may be included in the Part A composition of the adhesive system to modify physical properties, such as improved fixture speed, improved shelf-life stability, flexibility, thixotropy, increased viscosity, color, and improved toughness. Such additives therefore may be selected from accelerators, free radical stabilizers, anionic stabilizers, gelling agents, thickeners [such as PMMAs], thixotropy conferring agents (such as fumed silica), dyes, toughening agents, plasticizers and combinations thereof.

One or more accelerators may also be used in the adhesive system, particularly, in the Part A composition, to accelerate cure of the cyanoacrylate component. Such accelerators may be selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4,636,539, 4,695,615, 4,718,966, and 4,855,461, the disclosures of each of which are hereby expressly incorporated herein by reference.

For instance, as regards calixarenes, those within the structure below are useful herein:

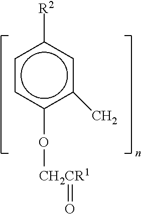

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, examples which may be used herein either individually or in combination include 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the structure below:

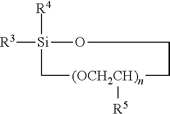

where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

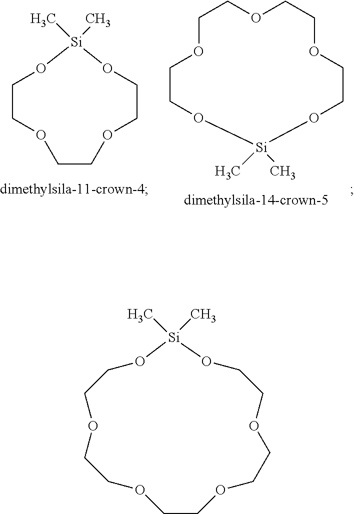

and dimethylsila-17-crown-6. See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference, as hydroxyl group derivatives of an α, β or γ-cyclodextrin (alpha-, beta-, or gamma-cyclodextrin) which is at least partly soluble in the cyanoacrylate would be appropriate choices for use herein as an accelerator component.

In addition, poly(ethylene glycol) di(meth)acrylates suitable for use herein include those within the structure below:

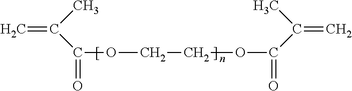

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG cC400 DMA.

And of the ethoxylated hydric compounds (or ethoxylated fatty alcohols that may be employed), appropriate ones may be chosen from those within the structure below:

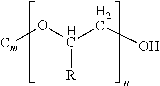

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

In addition, accelerators embraced within the structure below:

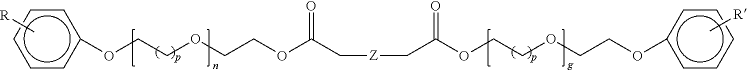

where R is hydrogen, C₁₋₆ alkyl, C₁₋₆ alkyloxy, alkyl thioethers, haloalkyl, carboxylic acid and esters thereof, sulfinic, sulfonic and sulfurous acids and esters, phosphinic, phosphonic and phosphorous acids and esters thereof, Z is a polyether linkage, n is 1-12 and p is 1-3 are as defined above, and R′ is the same as R, and g is the same as n.

A particularly desirable chemical within this class as an accelerator component is

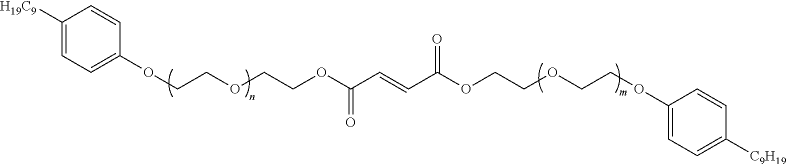

where n and m combined are greater than or equal to 12.

The accelerator may be included in the composition in an amount within the range of from about 0.01 weight percent to about 10 weight percent, with the range of about 0.1 to about 0.5 weight percent being desirable, and about 0.4 weight percent of the total composition being particularly desirable.

Stabilizers useful in the Part A composition of the adhesive system include free-radical stabilizers, anionic stabilizers and stabilizer packages that include combinations thereof. The identity and amount of such stabilizers are well known to those of ordinary skill in the art. See e.g. U.S. Pat. Nos. 5,530,037 and 6,607,632, the disclosures of each of which are hereby incorporated herein by reference. Commonly used free-radical stabilizers include hydroquinone, while commonly used anionic stabilizers include boron triflouride, boron trifluoride-etherate, sulphur trioxide (and hydrolysis products thereof) and methane sulfonic acid.

### Part B of the Composition

Free radical curable monomers for use in the Part B composition of the adhesive system include (meth)acrylate monomers, maleimide-, itaconamide- or nadimide-containing compounds and combinations thereof.

(Meth)acrylate monomers for use in Part B of the composition of the adhesive system include a host of (meth)acrylate monomers, with some of the (meth)acrylate monomers being aromatic, while others are aliphatic and still others are cycloaliphatic. Examples of such (meth)acrylate monomers include di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), bisphenol-F mono and di(meth)acrylates, such as ethoxylated bisphenol-F (meth)acrylate, and methacrylate-functional urethanes.

The maleimides, nadimides, and itaconimides include those compounds having the following structures I, II and III, respectively

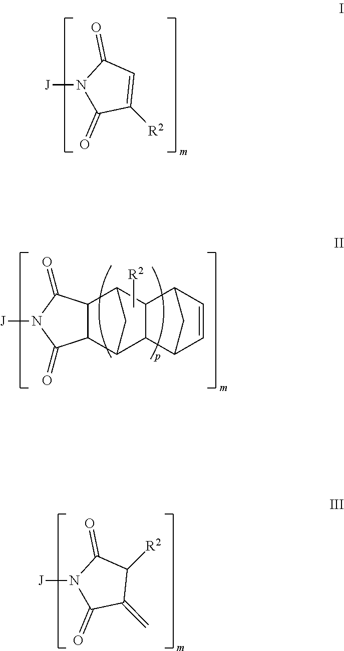

where:
m=1-15,
p=0-15,
   each R² is independently selected from hydrogen or lower alkyl, and
   J is a monovalent or a polyvalent moiety comprising organic or organosiloxane radicals, and combinations of two or more thereof.

More specific representations of the maleimides, itaconimides and nadimides include those corresponding to structures I, II, or III, where m=1-6, p=0, R² is independently selected from hydrogen or lower alkyl, and J is a monovalent or polyvalent radical selected from hydrocarbyl, substituted hydrocarbyl, heteroatom-containing hydrocarbyl, substituted heteroatom-containing hydrocarbyl, hydrocarbylene, substituted hydrocarbylene, heteroatom-containing hydrocarbylene, substituted heteroatom-containing hydrocarbylene, polysiloxane, polysiloxane-polyurethane block copolymer, and combinations of two or more thereof, optionally containing one or more linkers selected from a covalent bond, —O—, —S—, —NR—, —O—C(O)—, —O—C(O)—O—, —O—C(O)—NR—, —NR—C(O)—, —NR—C(O)—O—, —NR—C(O)—NR—, —S—C(O)—, —S—C(O)—O—, —S—C(O)—NR—, —S(O)—, —S(O)₂—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, —NR—P(O)R₂—, where each R is independently hydrogen, alkyl or substituted alkyl, and combinations of any two or more thereof.

When one or more of the above described monovalent or polyvalent groups contain one or more of the above described linkers to form the “J” appendage of a maleimide, nadimide or itaconimide group, as readily recognized by those of skill in the art, a wide variety of linkers can be produced, such as, for example, oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenyle, aminocycloalkenylene, carboxycycloalkenylene, oxyarylene, thioarylene, aminoarylene, carboxyarylene, oxyalkylarylene, thioarylalkylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, carboxyheteroatom-containing di- or polyvalent cyclic moiety, disulfide, sulfonamide, and the like.

In another embodiment, maleimides, nadimides, and itaconimides contemplated for use in the practice of the present invention have the structures I, II, and III, where m=1-6, p=0-6, and J is selected from saturated straight chain alkyl or branched chain alkyl, optionally containing optionally substituted aryl moieties as substituents on the alkyl chain or as part of the backbone of the alkyl chain, and where the alkyl chains have up to about 20 carbon atoms;
a siloxane having the structure: —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)—[Si(R⁴)₂—O]_{f}—Si(R⁴)₂—(C(R³)₂)ₑ—C(O)—(C(R³)₂)ₑ—, where:
each R³ is independently hydrogen, alkyl or substituted alkyl,
each R⁴ is independently hydrogen, lower alkyl or aryl,
d=1-10,
e=1-10, and
f=1-50;
   a polyalkylene oxide having the structure:

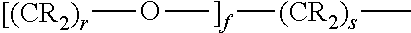

where:
each R is independently hydrogen, alkyl or substituted alkyl,
r=1-10,
s=1-10, and
f is as defined above;
aromatic groups having the structure:

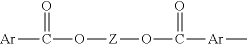

where:
each Ar is a monosubstituted, disubstituted or trisubstituted aromatic or heteroaromatic ring having in the range of 3 up to 10 carbon atoms, and
Z is:
   saturated straight chain alkylene or branched chain alkylene, optionally containing saturated cyclic moieties as substituents on the alkylene chain or as part of the backbone of the alkylene chain, or
   polyalkylene oxides having the structure:

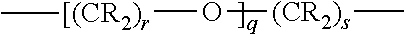

where:
   each R is independently hydrogen, alkyl or substituted alkyl, r and s are each defined as above, and
   q falls in the range of 1 up to 50;
   di- or tri-substituted aromatic moieties having the structure:

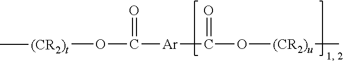

where:
each R is independently hydrogen, alkyl or substituted alkyl,
t falls in the range of 2 up to 10,
u falls in the range of 2 up to 10, and
Ar is as defined above;
   aromatic groups having the structure:

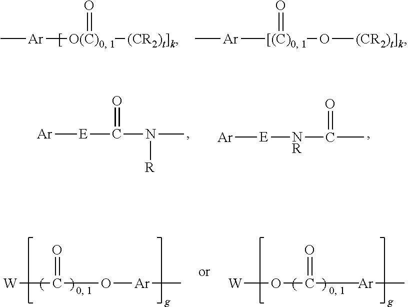

where:
each R is independently hydrogen, alkyl or substituted alkyl,
t=2-10,
k=1, 2 or 3,
g=1 up to about 50,
each Ar is as defined above,
E is —O— or —NR⁵—, where R⁵ is hydrogen or lower alkyl; and
W is straight or branched chain alkyl, alkylene, oxyalkylene, alkenyl, alkenylene, oxyalkenylene, ester, or polyester, a siloxane having the structure —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(R⁴)₂—(C(R³)₂)ₑ—C(O)O—(C(R³)₂)ₑ—, where:
   each R³ is independently hydrogen, alkyl or substituted alkyl,
   each R⁴ is independently hydrogen, lower alkyl or aryl,
   d=1-10,
   e=1-10, and
   f=1-50;
   a polyalkylene oxide having the structure:

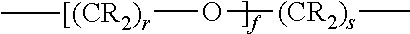

where:
each R is independently hydrogen, alkyl or substituted alkyl,
r=1-10,
s=1-10, and
f is as defined above;
optionally containing substituents selected from hydroxy, alkoxy, carboxy, nitrile, cycloalkyl or cycloalkenyl;
   a urethane group having the structure:

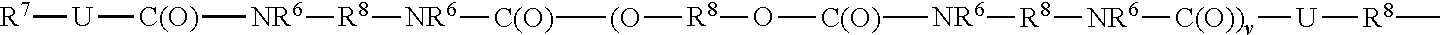

where:
each R⁶ is independently hydrogen or lower alkyl,
each R⁷ is independently an alkyl, aryl, or arylalkyl group having 1 to 18 carbon atoms,
each R⁸ is an alkyl or alkyloxy chain having up to about 100 atoms in the chain, optionally substituted with Ar,
U is —O—, —S—, —N(R)—, or —P(L)_{1,2}-,
   where R as defined above, and where each L is independently ═O, ═S, —OR or —R; and
v=0-50;
polycyclic alkenyl; or mixtures of any two or more thereof.

In a more specific recitation of such maleimide-, nadimide-, and itaconimide-containing compounds of structures I, II and III, respectively, each R is independently hydrogen or lower alkyl (such as C₁₋₄), -J- comprises a branched chain alkyl, alkylene, alkylene oxide, alkylene carboxyl or alkylene amido species having sufficient length and branching to render the maleimide, nadimide and/or itaconimide compound a liquid, and m is 1, 2 or 3.

Particularly desirable maleimide-containing compounds include those have two maleimide groups with an aromatic group therebetween, such as a phenyl, biphenyl, bisphenyl or naphthyl linkage.

In addition to the free radical curable component, Part B also includes a transition metal compound. A non-exhaustive list of representative examples of the transition metal compounds are copper, vanadium, cobalt and iron compounds. For instance, as regards copper compounds, copper compounds where copper enjoys a 1+ or 2+ valence state are desirable. A non-exhaustive list of examples of such copper (I) and (II) compounds include copper (II) 3,5-diisopropylsalicylate hydrate, copper bis(2,2,6,6-tetramethyl-3,5-heptanedionate), copper (II) hydroxide phosphate, copper (II) chloride, copper (II) acetate monohydrate, tetrakis(acetonitrile)copper (I) hexafluorophosphate, copper (II) formate hydrate, tetrakisacetonitrile copper (I) triflate, copper(II)tetrafluoroborate, copper (II) perchlorate, tetrakis(acetonitrile)copper (I) tetrafluoroborate, copper (II) hydroxide, copper (II) hexafluoroacetylacetonate hydrate and copper (II) carbonate. These copper (I) and (II) compounds may be used in an amount such that when dissolved or suspended in a carrier vehicle, such as a (meth)acrylate, a concentration of about 100 ppm to about 5,000 ppm, such as about 500 ppm to about 2,500 ppm, for instance about 1,000 ppm is present in the solution or suspension.

As regards vanadium compounds, vanadium compounds where vanadium enjoys a 2+ and 3+ valence state are desirable. Examples of such vanadium (III) compounds include vanadyl naphthenate and vanadyl acetylacetonate. These vanadium (III) compounds may be used in an amount of 50 ppm to about 5,000 ppm, such as about 500 ppm to about 2,500 ppm, for instance about 1,000 ppm.

As regards cobalt compounds, cobalt compounds where cobalt enjoys a 2+ valence state are desirable. Examples of such cobalt (II) compounds include cobalt naphthenate, cobalt tetrafluoroborate and cobalt acetylacetonate. These cobalt (II) compounds may be used in an amount of about 100 ppm to about 1000 ppm.

As regards iron compounds, iron compounds where iron enjoys a 3+ valence state are desirable. Examples of such iron (III) compounds include iron acetate, iron acetylacetonate, iron tetrafluoroborate, iron perchlorate, and iron chloride. These iron compounds may be used in an amount of about 100 ppm to about 1000 ppm.

As discussed above, additives may be included in either or both of the Part A or the Part B compositions to influence a variety of performance properties.

Fillers contemplated for use include, for example, aluminum nitride, boron nitride, silicon carbide, diamond, graphite, beryllium oxide, magnesia, silicas, such as fumed silica or fused silica, alumina, perfluorinated hydrocarbon polymers (i.e., TEFLON®), thermoplastic polymers, thermoplastic elastomers, mica, glass powder and the like. Preferably, the particle size of these fillers will be about 20 microns or less.

As regards silicas, the silica may have a mean particle diameter on the nanoparticle size; that is, having a mean particle diameter on the order of 10-9 meters. The silica nanoparticles can be pre-dispersed in epoxy resins, and may be selected from those available under the tradename NANOPOCRYL, from Nanoresins, Germany. NANOCRYL is a tradename for a product family of silica nanoparticle reinforced (meth)acrylates. The silica phase consists of surface-modified, synthetic SiO₂ nanospheres with less than 50 nm diameter and an extremely narrow particle size distribution. The SiO₂ nanospheres are agglomerate-free dispersions in the (meth)acrylate matrix resulting in a low viscosity for resins containing up to 50 weight percent silica.

The silica component may be present in an amount in the range of about 1 to about 60 weight percent, such as about 3 to about 30 weight percent, desirably about 5 to about 20 weight percent, based on the total weight of the composition.

Tougheners contemplated for use particularly in the Part A composition include elastomeric polymers selected from elastomeric copolymers of a lower alkene monomer and (i) acrylic acid esters, (ii) methacrylic acid esters or (iii) vinyl acetate, such as acrylic rubbers; polyester urethanes; ethylene-vinyl acetates; fluorinated rubbers; isoprene-acrylonitrile polymers; chlorosulfinated polyethylenes; and homopolymers of polyvinyl acetate were found to be particularly useful. [See U.S. Pat. No. 4,440,910 (O'Connor), the disclosures of each of which are hereby expressly incorporated herein by reference.] The elastomeric polymers are described in the '910 patent as either homopolymers of alkyl esters of acrylic acid; copolymers of another polymerizable monomer, such as lower alkenes, with an alkyl or alkoxy ester of acrylic acid; and copolymers of alkyl or alkoxy esters of acrylic acid. Other unsaturated monomers which may be copolymerized with the alkyl and alkoxy esters of acrylic include dienes, reactive halogen-containing unsaturated compounds and other acrylic monomers such as acrylamides.

For instance, one group of such elastomeric polymers are copolymers of methyl acrylate and ethylene, manufactured by DuPont, under the name of VAMAC, such as VAMAC N123 and VAMAC B-124. VAMAC N123 and VAMAC B-124 are reported by DuPont to be a master batch of ethylene/acrylic elastomer. The DuPont material VAMAC G is a similar copolymer, but contains no fillers to provide color or stabilizers. VAMAC VCS rubber appears to be the base rubber, from which the remaining members of the VAMAC product line are compounded. VAMAC VCS (also known as VAMAC MR) is a reaction product of the combination of ethylene, methyl acrylate and monomers having carboxylic acid cure sites, which once formed is then substantially free of processing aids (such as the release agents octadecyl amine, complex organic phosphate esters and/or stearic acid), and anti-oxidants (such as substituted diphenyl amine).

DuPont provides to the market under the trade designation VAMAC VMX 1012 and VCD 6200, rubbers which are made from ethylene and methyl acrylate. It is believed that the VAMAC VMX 1012 rubber possesses little to no carboxylic acid in the polymer backbone. Like the VAMAC VCS rubber, the VAMAC VMX 1012 and VCD 6200 rubbers are substantially free of processing aids such as the release agents octadecyl amine, complex organic phosphate esters and/or stearic acid, and anti-oxidants, such as substituted diphenyl amine, noted above. All of these VAMAC elastomeric polymers are useful herein.

In addition, vinylidene chloride-acrylonitrile copolymers [see U.S. Pat. No. 4,102,945 (Gleave)] and vinyl chloride/vinyl acetate copolymers [see U.S. Pat. No. 4,444,933 (Columbus)] may be included in the Part A composition. Of course, the disclosures of each these U.S. patents are hereby incorporated herein by reference in their entirety.

Copolymers of polyethylene and polyvinyl acetate, available commercially under the trade name LEVAMELT by LANXESS Limited, are useful.

A range of LEVAMELT-branded copolymers are available and includes for example, LEVAMELT 400, LEVAMELT 600 and LEVAMELT 900. The LEVAMELT products differ in the amount of vinyl acetate present. For example, LEVAMELT 400 comprises an ethylene-vinyl acetate copolymer comprising 40 weight percent vinyl acetate. The LEVAMELT products are supplied in granular form. The granules are almost colourless and dusted with silica and talc. LEVAMELT consists of methylene units forming a saturated main chain with pendant acetate groups. The presence of a fully saturated main chain is an indication that LEVAMELT-branded copolymers are particularly stable; they does not contain any reactive double bonds which make conventional rubbers prone to aging reactions, ozone and UV light. The saturated backbone is reported to make the polymer robust.

Interestingly, depending on the ratio of polyethylene/polyvinylacetate, the solubilities of these LEVAMELT elastomers change in different monomers and also the ability to toughen changes as a result of the solubility.

The LEVAMELT elastomers are available in pellet form and are easier to formulate than other known elastomeric toughening agents.

VINNOL surface coating resins available commercially from Wacker Chemie AG, Munich, Germany represent a broad range of vinyl chloride-derived copolymers and terpolymers that are promoted for use in different industrial applications. The main constituents of these polymers are different compositions of vinyl chloride and vinyl acetate. The terpolymers of the VINNOL product line additionally contain carboxyl or hydroxyl groups. These vinyl chloride/vinyl acetate copolymers and terpolymers may also be used.

VINNOL surface coating resins with carboxyl groups are terpolymers of vinyl chloride, vinyl acetate and dicarboxylic acids, varying in terms of their molar composition and degree and process of polymerization. These terpolymers are reported to show excellent adhesion, particularly on metallic substrates.

VINNOL surface coating resins with hydroxyl groups are copolymers and terpolymers of vinyl chloride, hydroxyacrylate and dicarboxylate, varying in terms of their composition and degree of polymerization.

VINNOL surface coating resins without functional groups are copolymers of vinyl chloride and vinyl acetate of variable molar composition and degree of polymerization.

Rubber particles, especially rubber particles that have relatively small average particle size (e.g., less than about 500 nm or less than about 200 nm), may also be included, particularly in the Part B composition. The rubber particles may or may not have a shell common to known core-shell structures.

In the case of rubber particles having a core-shell structure, such particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.). For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also be suitably be used for the core, including polybutylacrylate or polysiloxane elastomer (e.g., polydimethylsiloxane, particularly crosslinked polydimethylsiloxane).

Typically, the core will comprise from about 50 to about 95 weight percent of the rubber particles while the shell will comprise from about 5 to about 50 weight percent of the rubber particles.

Preferably, the rubber particles are relatively small in size. For example, the average particle size may be from about 0.03 to about 2 microns or from about 0.05 to about 1 micron. The rubber particles may have an average diameter of less than about 500 nm, such as less than about 200 nm. For example, the core-shell rubber particles may have an average diameter within the range of from about 25 to about 200 nm.

When used, these core shell rubbers allow for toughening to occur in the composition and oftentimes in a predictable manner—in terms of temperature neutrality toward cure—because of the substantial uniform dispersion, which is ordinarily observed in the core shell rubbers as they are offered for sale commercially.

In the case of those rubber particles that do not have such a shell, the rubber particles may be based on the core of such structures.

Desirably, the rubber particles are relatively small in size. For example, the average particle size may be from about 0.03 to about 2 μm or from about 0.05 to about 1 μm. In certain embodiments of the invention, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm.

The rubber particles may be used in a dry form or may be dispersed in a matrix, as noted above.

Typically, the composition may contain from about 5 to about 35 weight percent rubber particles.

Combinations of different rubber particles may advantageously be used in the present invention. The rubber particles may differ, for example, in particle size, the glass transition temperatures of their respective materials, whether, to what extent and by what the materials are functionalized, and whether and how their surfaces are treated.

Rubber particles that are suitable for use in the present invention are available from commercial sources. For example, rubber particles supplied by Eliokem, Inc. may be used, such as NEP R0401 and NEP R401S (both based on acrylonitrile/butadiene copolymer); NEP R0501 (based on carboxylated acrylonitrile/butadiene copolymer; CAS No. 9010-81-5); NEP R0601A (based on hydroxy-terminated polydimethylsiloxane; CAS No. 70131-67-8); and NEP R0701 and NEP 07015 (based on butadiene/styrene/2-vinylpyridine copolymer; CAS No. 25053-48-9). Also those available under the PARALOID tradename, such as PARALOID 2314, PARALOID 2300, and PARALOID 2600, from Dow Chemical Co., Philadelphia, PA, and those available under the STAPHYLOID tradename, such as STAPHYLOID AC-3832, from Ganz Chemical Co., Ltd., Osaka, Japan.

Rubber particles that have been treated with a reactive gas or other reagent to modify the outer surfaces of the particles by, for instance, creating polar groups (e.g., hydroxyl groups, carboxylic acid groups) on the particle surface, are also suitable for use herein. Illustrative reactive gases include, for example, ozone, Cl₂, F₂, O₂, SO₃, and oxidative gases. Methods of surface modifying rubber particles using such reagents are known in the art and are described, for example, in U.S. Pat. Nos. 5,382,635; 5,506,283; 5,693,714; and 5,969,053, each of which being hereby expressly incorporated herein by reference in its entirety. Suitable surface modified rubber particles are also available from commercial sources, such as the rubbers sold under the tradename VISTAMER by Exousia Corporation.

Where the rubber particles are initially provided in dry form, it may be advantageous to ensure that such particles are well dispersed in the adhesive composition prior to curing the adhesive composition. That is, agglomerates of the rubber particles are preferably broken up so as to provide discrete individual rubber particles, which may be accomplished by intimate and thorough mixing of the dry rubber particles with other components of the adhesive composition.

Thickeners may also be useful.

Stabilizers and inhibitors may also be employed to control and prevent premature peroxide decomposition and polymerization. The inhibitors may be selected from hydroquinones, benzoquinones, naphthoquinones, phenanthroquinones, anthraquinones, and substituted compounds thereof. Various phenols may also be used as inhibitors, such as 2,6-di-tertiary-butyl-4-methyl phenol. The inhibitors may be used in quantities of about 0.1% to about 1.0% by weight of the total composition without adverse effect on the curing rate of the polymerizable adhesive composition.

At least one of the first part or the second part may also include an organic acid having a pKₐ of about 12 or less, such as sulfimides, sulfonamides, citric acid, maleic acid, succinic acid, phthalic acid, di-carboxylic acid, maleic anhydride, maleic dianhydride, succinic anhydride, and phthalic anhydride.

In practice, each of the Part A and the Part B compositions are housed in separate containment vessels in a device prior to use, where in use the two parts are expressed from the vessels mixed and applied onto a substrate surface. The vessels may be chambers of a dual chambered cartridge, where the separate parts are advanced through the chambers with plungers through an orifice (which may be a common one or adjacent ones) and then through a mixing dispense nozzle. Or the vessels may be coaxial or side-by-side pouches, which may be cut or torn and the contents thereof mixed and applied onto a substrate surface.

The invention will be more readily appreciated by a review of the examples, which follow.

### Examples

### Methods

In brief the bonding of the parts to be were tested was performed as follows. Bonds were prepared in a number of ways: (a) dispensed and cured on bench; (b) dispensed on bench and cured underwater; (c) dispensed underwater and cured on the bench; (d) dispensed and cured underwater. All methods were carried out at room temperature.

Where part or all of the bonding was carried out underwater, the parts were submerged in water, such that the water was in contact with all surfaces of the parts. The parts were fully submerged. The parts were not removed from the water prior to application of the adhesive.

Adhesive was dispensed from a container and applied to a first part. A second part was overlapped by 0.5 inch (1.27 cm) and the parts were clamped together so that the adhesive cured to form a bond between the parts. The amount of time between dispensation from the container and overlapping the second part is the open time. Both the application of the adhesive and curing of the adhesive were performed underwater. For testing dry parts the parts were not placed underwater. The parts were dry, that is free from surface moisture, when the adhesive was applied and when the adhesive was cured.

The following substrates were tested: stainless steel, aluminium, mild steel, PC, PVC, and ABS.

### Results

Table 1 shows the tensile strengths achieved with various substrates and bonding conditions according to methods (a)-(d) above.

TABLE 1

| | Dispense/cure | Tensile |
|---|---|---|
| Substrate | conditions | strength N/mm² |
| Stainless steel | a | 23.7 |
| lapshears | b | 14.3 |
| | c | 8.5 |
| | d | 7.3 |
| Aluminium | a | 16.6 |
| lapshears | b | 7.6 |
| | c | 6.1 |
| | d | 3.4 |
| Mild steel | a | 19.8 |
| lapshears | b | 9.9 |
| | d | 4.6 |
| Polycarbonate (PC) | a | 3.1 |
| lapshears | b | 2.2 |
| | d | 0.7 |
| Polyvinylchloride | a | 4.3 |
| (PVC) lapshears | b | 3.5 |
| | d | 0.7 |
| Acrylonitrile | a | 4.9 |
| butadiene styrene | b | 3.5 |
| (ABS) lapshears | d | 2.0 |

Performance of the cartridges of an adhesive suitable for use in the invention were also checked after being stored underwater (Tables 2 and 3). After 7 days underwater, no evidence of polymerisations was found in or around the cartridge and performance was not affected.

TABLE 2

| Time cartridge | | |
|---|---|---|
| submerged in | Dispense | |
| water | possible? | Visual inspection |
| 4 hours | Yes | No evidence of polymerization |
| 24 hours | Yes | No evidence of polymerization |
| 6 days | Yes | No evidence of polymerization |
| 7 days | Yes | No evidence of polymerization |

TABLE 3

| | | | Tensile strength |
|---|---|---|---|
| | | Tensile | N/mm² with no |
| Time | Substrate | strength N/mm² | submersion (Table 1) |
| 7 days | Stainless | 20.9 | 23.7 |
| | steel | | |
| | lapshears | | |
| 7 days | Aluminium | 16.6 | 16.6 |
| | lapshears | | |

Performance was also tested on nuts and bolts bonded according to the invention. Substrates were prepared as described above. Results are shown in Table 4.

TABLE 4

| | Dispense/cure | | |
|---|---|---|---|
| Substrate | conditions | Torque (Nm) | Prevail (Nm) |
| Stainless | a | 36.4 | 21.4 |
| steel nuts | b | 31.9 | 20.6 |
| and bolts | d | 6.1 | 2.4 |
| BOMS nuts | a | 48.6 | 21.9 |
| and bolts | b | 45.6 | 25.6 |
| | d | 2.5 | 2.6 |

Tensile strength measurements were carried out according to ASTM D1002-10(2019) for metal to metal lapshears and according to ASTM D3163-01(2023) for plastic to plastic lapshears.

The stainless steel bolts have a major diameter from 9.968 to 9.732 mm, a minor diameter from 8.619 to 8.272 mm, and a pitch circle diameter of 8.994 to 8.862 mm. The stainless steel nuts have a thickness of 7.64 to 8.00 mm, a width of 16.73 to 17.00 mm, a major diameter of 10.0 minimum, a minor diameter of 8.376 to 8.676 mm and a pitch circle diameter from 9.026 to 9.206 mm.

BOMS refers to black oxide mild steel. The mild steel bolts are coated with black oxide. The mild steel nuts used were not coated with black oxide. The torque values in the last two columns of Table 4 are respectively breakaway torque (or break torque) and prevailing torque (or prevail torque) and all values were measured in accordance with ASTM D5649-15, titled, “Torque Strength of Adhesives used on Threaded Fasteners.”

The black oxide mild steel bolts have a major diameter from 9.96 to 9.73 mm, a minor diameter from 8.08 to 7.98 mm, and a pitch circle diameter of 8.99 to 8.86 mm. The mild steel nuts have a thickness of 8±0.2 mm, a width of 14.0 to 14.3 mm, a major diameter of 10.0 minimum, a minor diameter of 8.38 to 8.28 mm and a pitch circle diameter from 9.20 to 9.03 mm.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of bonding substrates that are underwater comprising:
(a) applying, underwater, a cyanoacrylate composition to at least one substrate, wherein the cyanoacrylate composition comprises:
i. a first part comprising a cyanoacrylate component and a peroxide catalyst; and
ii. a second part comprising a free radical curable component and a transition metal,
wherein when mixed together the peroxide catalyst initiates cure of the free radical curable component and the transition metal initiates cure of the cyanoacrylate component,
(b) allowing the composition to cure underwater.

2. The method of claim 1 wherein the cyanoacrylate component comprises H₂C═C(CN)—COOR, wherein R is selected from alkyl, alkoxyalkyl, cycloalkyl, alkenyl, aralkyl, aryl, allyl and haloalkyl groups.

3. The method of claim 1 wherein the peroxide catalyst comprises perbenzoates.

4. The method of claim 1 wherein the peroxide catalyst is t-butyl perbenzoate.

5. The method of claim 1 wherein at least one of the first part or the second part further comprises a member selected from the group consisting of an organic acid having a pKₐ of about 12 or less, such as sulfimides, sulfonamides, citric acid, maleic acid, succinic acid, phthalic acid, di-carboxylic acid, maleic anhydride, maleic dianhydride, succinic anhydride, and phthalic anhydride, or a combination thereof.

6. The method of claim 1 wherein the peroxide catalyst is present in an amount from about 0.01% to about 10%, by weight of the cyanoacrylate component.

7. The method of according to claim 1 wherein the free radical curable component of the composition is selected from a (meth)acrylate component, maleimide-, itaconamide- or nadimide-containing compounds, and combinations thereof.

8. The method of according to claim 1 wherein the free radical curable component of the composition is a (meth)acrylate component selected from the group consisting of polyethylene glycol di(meth)acrylates, tetrahydrofuran (meth)acrylates and di(meth)acrylates, hydroxypropyl (meth)acrylate, hexanediol di(meth)acrylate, trimethylol propane tri(meth)acrylate, diethylene glycol dimethacrylate, triethylene glycol dimethacrylate, benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates.

9. The method of claim 1 wherein the transition metal of the composition comprises a member selected from the group consisting of copper, vanadium, cobalt and iron.

10. The method of claim 1 wherein the first part of the composition is housed in a first chamber of a dual chamber syringe and the second part of the composition is housed in a second chamber of the dual chamber syringe.

11. The method of claim 1 wherein the second part of the composition further comprises at least one of a plasticizer, and a filler.

12. The method of claim 1 wherein the second part of the composition further comprises a toughener, optionally the toughener is a member selected from the group consisting of (a) reaction products of the combination of ethylene, methyl acrylate and monomers having carboxylic acid cure sites, (b) dipolymers of ethylene and methyl acrylate, (c) combinations of (a) and (b), (4) vinylidene chloride-acrylonitrile copolymers, (5) and vinyl chloride/vinyl acetate copolymer, (6) copolymers of polyethylene and polyvinyl acetate, and combinations thereof.

13. The method of claim 1 wherein the first part of the composition and the second part of the composition are present in a ratio of about 1:1 by volume.

14. The method of claim 1 wherein the first part of the composition and the second part of the composition are each housed in a separate chamber of a dual chambered container.

15. The method of claim 1 wherein at least one of the first part of the composition or the second part of the composition further comprises a member selected from the group consisting of sulfimides, sulfonamides, citric acid, maleic acid, succinic acid, phthalic acid, di-carboxylic acid, maleic anhydride, maleic dianhydride, succinic anhydride, phthalic anhydride, and combinations thereof.

16. The method of claim 1 wherein the free radical curable component is a (meth)acrylate component selected from the group consisting of ethoxylated bisphenol-A (meth)acrylate, ethoxylated bisphenol-F (meth)acrylate, methacrylate-functional urethanes, and combinations thereof.

17. The method of claim 1 wherein the transition metal comprises copper in the form of a member selected from the group consisting of copper (II) 3,5-diisopropylsalicylate hydrate, copper bis(2,2,6,6-tetramethyl-3,5-heptanedionate), copper (II) hydroxide phosphate, copper (II) chloride, copper (II) acetate monohydrate, tetrakis(acetonitrile)copper (I) hexafluorophosphate, copper (II) formate hydrate, tetrakisacetonitrile copper (I) triflate, copper(II)tetrafluoroborate, copper (II) perchlorate, tetrakis(acetonitrile)copper (I) tetrafluoroborate, copper (II) hydroxide, copper (II) hexafluoroacetylacetonate hydrate and copper (II) carbonate.

18. The method of claim 1 comprising exposing the composition to water for up to 45 seconds prior to joining the surface of the seconds substrate with the coated surface of the first substrate.

19. The method of claim 1 wherein one or both substrates is a metal, for example wherein one or both substrates is steel.

20. The method of claim 1 wherein one or both substrates is a plastics material.

21. An assembly comprising two underwater substrates that are bonded together by a cyanoacrylate composition comprising:
i. a first part comprising a cyanoacrylate component and t-butyl perbenzoate as a peroxide catalyst present in an amount from about 0.01% to about 10%, by weight of the cyanoacrylate component; and
ii. a second part comprising a free radical curable component and a transition metal,
wherein the cyanoacrylate component comprises H₂C═C(CN)—COOR, wherein R is selected from alkyl, alkoxyalkyl, cycloalkyl, alkenyl, aralkyl, aryl, allyl and haloalkyl groups, and wherein when mixed together the peroxide catalyst initiates cure of the free radical curable component and the transition metal initiates cure of the cyanoacrylate component.

22. The assembly of claim 21 wherein one or both of the substrates is a metal.

23. The assembly of claim 21 wherein one or both substrates is a plastics material.
